(19) United States
(12) Patent Application Publication
(10) Pub. No.: US 2005/0153045 A1
(43) Pub. Date: Jul. 14, 2005

(54) Method for formation of enhanced expandable food products

(76) Inventors: Lamar Johnson, Carver, MN (US); Chris Willoughby, Battle Creek, MI (US); Michael N. Bauman, Battle Creek, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/994,723

(22) Filed: Nov. 22, 2004

Related U.S. Application Data
(60) Provisional application No. 60/524,285, filed on Nov. 21, 2003.

(51) Int. Cl. A21D 13/00

(52) U.S. Cl. 426/559

(57) ABSTRACT

A method of forming an expandable food product having enhanced expandability is disclosed. In the method a cooked starchy farinaceous composition is treated by flash frying in a heated media for a period of from 1 to 15 seconds. The flash fry treatment leads to enhanced expandability, an enhanced percentage of expanded pieces, enhanced coating retention, and an enhanced high fat mouth feel to the food product. The flash fry media can be an edible oil, a paraffin, or a caustic bath of baking soda in water. The product produced has unique consumer appeal.

### RELATED APPLICATIONS

This application claims the benefit of U.S. Provisional Application No. 60/524,285, filed Nov. 21, 2003.

### STATEMENT REGARDING FEDERALLY SPONSORED RESEARCH

NONE

### TECHNICAL FIELD

This invention relates generally to formation of expandable food products and, more particularly, to a method for formation of expandable food products with enhanced expandability.

### BACKGROUND OF THE INVENTION

Consumers have access to a wide variety of food products in the present day. Food producers are continually seeking ways to differentiate their food products from those of their competitors. This differentiation can include coloring, flavoring, design, unique taste, or unique eating experiences. Recently consumers have been offered a variety of expandable food products to offer unique dining experiences. Expandable food products are defined as food products that upon heating puff and increase in volume by at least 50% and often times by several fold. The novelty of these food products and their taste characteristics are highly desired by consumers. Typically, such a food product comprises a starchy farinaceous composition that is formed into an expandable food product. The food product is generally presented to the consumer in the form of an expandable food product. The consumer then reheats the expandable food product in any of a number of conventional ways including oven heating, hot air heating or microwave oven heating. Upon heating the expandable food product expands in size anywhere from 50% to 7-8 fold to become the expanded food product. These food products provide fresh, hot, and novel eating experiences for the consumer and are highly desired. Examples of such expandable food products can be found in U.S. Pat. Nos. 6,171,631 and 6,319,534. These products are typically formed by a cooker extruder process or injection molding process. Although these products have received high marks from consumers for their appeal there are a number of difficulties associated with these food products.

One of the difficulties associated with current expandable food products is that the degree of expansion is not always as large as is desirable. In addition, an ongoing problem is that a percentage of the expandable food pieces never expand even upon heating. This produces a food product that has a majority of expanded food pieces but a percentage of unexpanded food pieces. The unexpanded food pieces are inedible by consumers and detract from consumer appeal for the expanded food product. During the heating stage to expand the expandable food product there are times when one or more pieces are stacked on top of one another. Often times during the heating process these stacked pieces fuse to each other and do not expand also leading to reduced consumer appeal. Consumers often desire to have additional flavors or seasonings applied to the food product. Prior expandable food products have a low retention capability for coatings of other seasonings or flavoring ingredients. Finally, it is always desirable to try to produce an expandable food product that will have an organoleptic profile of a higher fat food product utilizing a low fat formulation.

Thus, it would be desirable to develop a method for preparing an expandable food product that would enhance the degree and reliability of puffing of the expandable food product, enhance the ability to retain coatings on the expanded food product, and provide additional taste functionality to the expanded food product. Another advantage of this technology is that it would enable a new ready to eat, puffed food form. Because of the improved puffing characteristics and the improved adhesion of the seasonings, it is possible to puff these products similar to Rice Cakes creating to whole new range flavors, textures, and colors.

### SUMMARY OF THE INVENTION

In one embodiment, the present invention is a method of forming an expandable food product comprising the steps of: providing a starchy farinaceous composition; cooking the starchy farinaceous composition; and flash frying the cooked composition in a frying media at a temperature of from 145 to 205° C. for a period of time of from 1 to 15 seconds, thereby forming an expandable food product.

In another embodiment, the present invention is a method of forming an expandable food product comprising the steps of: providing a starchy farinaceous composition; cooking the starchy farinaceous composition; and flash frying the cooked composition in a caustic media at a temperature of from 70 to 85° C. for a period of time of from 1 to 15 seconds, thereby forming an expandable food product.

The present invention also includes expandable food products made by the methods. These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a photograph of an injection molded starchy farinaceous composition prepared in accordance with the present invention;

FIG. 2 is a photograph of an injection molded starchy farinaceous composition after 3 seconds of flash frying in accordance with the present invention;

FIG. 3 is a photograph of an injection molded starchy farinaceous composition after 6 seconds of flash frying in accordance with the present invention;

FIG. 4 is a photograph of an injection molded starchy farinaceous composition after 10 seconds of flash frying in accordance with the present invention; and

FIG. 5 is a photograph of an injection molded starchy farinaceous composition after 15 seconds of flash frying in accordance with the present invention.

### DETAILED DESCRIPTION OF A PREFERRED EMBODIMENT

The general process of the present invention begins with an at least partially cooked starchy farinaceous composition that is not expanded from the uncooked state. The cooking step must be sufficient to modify the starch in the starchy farinaceous material from its native structure. Preferably, the composition is fully cooked. The cooked starchy farinaceous composition is then flash fried for a short period of time of less than or equal to 15 seconds. The flash fried composition is then an enhanced expandable food product. It is termed an expandable food product because prior to consumption it is subjected to addition heating to cause its expansion by 2 to 10 fold thereby forming the fully expanded food product. Generally, the final expansion is carried out by a consumer; however, it can also be done prior to distribution to a consumer. The flash frying of the present invention greatly enhances the ability of an expandable food product to expand during the subsequent heating.

### Starchy Farinaceous Composition

The starchy farinaceous composition includes a starchy farinaceous material in any of a variety of forms including flour, whole grain, pre-processed whole grain, whole grain particles such as grits, and mixtures thereof. The source of the grain can comprise barley, buckwheat, corn, millet, oat, rice, rye, sorghum, wheat, or combinations of these grains. The grains can also be pre-processed as in rotary cooked, bumped, or pregelatinized. The rotary cooking preferably comprises cooking the grain for about 30 to 90 minutes at a pressure of from about 10 to 30 pounds per square inch (psi). The grain can also be pre-processed by steeping.

The starchy farinaceous material typically comprises from about 1 to 100% by weight of the composition, more preferably from 20 to 95%, and most preferably from about 60 to 90%. The composition may optionally include other materials such as seasonings, sweeteners, fruit, flavorants, colorants, texturizing agents, preservatives, lubricants, oils, emulsifiers, sources of protein, vitamins, minerals, and added water. The sweeteners may be those know by those of ordinary skill in the art including natural sweeteners such as sugar and artificial sweeteners such as aspartame or saccharine. Preferably the sweeteners are present in an amount of from 1 to 50% by weight, and more preferably from 1 to 20%. The fruit can either be fruit pieces or processed fruit such as dried, powdered, pureed, or freeze dried fruit. The fruit may be present in an amount of from 1 to 50% by weight. Preferably the water content of the composition is from about 1 to 40% by weight based on the weight of the composition, more preferably from 5 to 20%, and most preferably from 10 to 18%. The composition may also include any edible oil known to those of ordinary skill in the art and is preferably present in an amount of from about 1 to 20% by weight. The protein source can comprise any known in the art source including soy protein, soy protein isolate, whey protein, whey protein isolate, textured vegetable protein, caseinate, gelatin, wheat gluten, or combinations or these proteins. When present the protein source is preferably present in an amount of from 1 to 10% by weight based on the total weight and more preferably in an amount of from 2 to 5%. The seasonings can include virtually any desired seasoning or flavor including salt, garlic, herbs, natural and or artificial flavorings, cheese powder, chili powder, pepper, hot peppers, savory seasonings, vegetable powders, and combinations thereof.

### Cooking the Farinaceous Composition

After its formation the starchy farinaceous composition is then cooked. The cooking can be accomplished in any of a number of ways including using a cooker extruder, rotary cooking, or injection molding. The moisture of the composition during cooking can be up to about 40% by weight depending on the cooking method. The rotary cooker conditions are provided above. The cooker extruder or rotary cooked composition can then be formed in a cold forming extruder to the desired shape or form or formed directly from the cooker extruder. The formed pieces or shapes are then dried to a final moisture content of from about 10 to 25% by weight, more preferably from 12 to 18%, and most preferably from 12 to 16%. The cooking should be at a sufficient temperature and pressure to disrupt the native structure of the starch. Typical cooker extruder conditions comprise a temperature of from about 90 to 205° C., and more preferably from 90 to 150° C. The food pressures achieved in the cooker extruder should preferably be from 200 to 3,000 psi. As discussed the extrudate from the cooker extruder can be passed through cold former extruder if desired. If this route is followed then it is permissible to allow the extrudate to expand from 2 to 20 fold as it exits the cooker extruder. The extrudate is then fed into a cold former extruder where it is degassed and recompressed to the desired shape. The extrudate exiting the cold former extruder does not expand as it is extruded. Alternatively the cooker extruder conditions can be chosen so the extrudate does not expand as it exits the cooker extruder. In either route the product obtained for flash frying is a compacted extrudate. As noted the pieces can have virtually any shape. They could be shaped as pellets, donuts, cracker shapes, or other shapes. The cut pieces are the dried to a final moisture of from 10 to 25% by weight, more preferably from 12 to 18%, and most preferably from 12 to 16%. The present invention is not applied to direct expanded products that are know to those of ordinary skill in the art. Such products can not be further expanded by additional heating. Many ready to eat cereals are direct expanded which occurs as they are extruded from an extruder cooker and the resulting release in pressure causes the water in the extrudate to rapidly leave and thereby expand the extrudate. In the present invention the extrudate conditions are chosen to prevent expansion of the extrude as it leaves the extruder. In Table 1 below are presented a set of nine non-limiting examples of starchy farinaceous compositions that show a variety of potential compositions.

As described above the components and their amounts that could be included in the composition are numerous.

TABLE 1

| Ingredient | #1 | #2 | #3 | #4 | #5 | #6 | #7 | #8 | #9 |
|---|---|---|---|---|---|---|---|---|---|
| Corn | 43 | 42 | 93 | 43 | 49.95 | | | 43 | 43 |
| Flour | | | | | | | | | |
| Pre- | | | | | 20 | | | | |
| gelatinized | | | | | | | | | |
| corn flour | | | | | | | | | |
| Wheat | 30 | | | 10 | | 49.95 | | 10 | 30 |
| Flour | | | | | | | | | |
| Pre- | | | | | | 20 | | | |
| gelatinized | | | | | | | | | |
| wheat | | | | | | | | | |
| flour | | | | | | | | | |
| Ultra-fine | | | | 30 | | | | 30 | |
| grind | | | | | | | | | |
| wheat | | | | | | | | | |
| bran | | | | | | | | | |
| Oat flour | 20 | 14 | | 10 | | | 49.95 | 10 | 20 |
| Pre- | | | | | | | | | |
| gelatinized | | | | | | | | | |
| rice flour | | | | | | | | | |
| Ultra-crisp | | 24.75 | | | | | | | |
| food | | | | | | | | | |
| starch | | | | | | | | | |
| Kaomel | .75 | 10 | .75 | 1 | 8 | 8 | 5 | .75 | .75 |
| oil | | | | | | | | | |
| Dimodan | .25 | | .25 | | | | | .25 | .25 |
| (emulsi- | | | | | | | | | |
| fier) | | | | | | | | | |
| Sugar | 4 | 8 | 4 | 4 | | | | 4 | 4 |
| Salt | 2 | 1.25 | 2 | 2 | 2 | 2 | 2 | 2 | 2 |
| Garlic | | | | | .05 | .05 | .05 | | |
| 10× | | | | | 20 | 20 | 20 | | |
| powdered | | | | | | | | | |
| sugar | | | | | | | | | |

The compositions of Table 1 can be prepared by blending the ingredients and extruding the composition through a twin screw extruder at a moisture content of from 15 to 25% under the temperature and pressure conditions described above. The extrudate is then cut into pieces. The pieces are then dried to a final moisture content as described above.

As noted the composition can also be cooked and formed in an injection molder as described in U.S. Pat. No. 6,319,534, hereby incorporated by reference. Briefly, the injection molding assembly includes an extruder portion and a mold portion. The mold portion includes a runner, gates and shaped molds. The extruder portion includes a screw feed section, heated chamber and a nozzle. The screw feed section is heated to a temperature of from 37 to 205° C., and more preferably from 90 to 150° C. The screw feed moves the farinaceous composition to the pressurized heated chamber. The hydraulic pressure of the screw feed in the chamber is high enough to produce a food pressure of from about 10,000 to 50,000 psi, more preferably from 10,000 to 30,000 psi. Preferably the chamber is heated to the same temperature range as the screw feed. The extrudate is then forced at the high food pressures through the nozzle into the runner. The runner distributes the food mass under high pressure through the gates and into the shaped molds. The shaped molds are preferably cooled to cause the injected food mass to set and retain the shape of the shaped mold. Preferably the cooling fluid cooling the mold is kept at a temperature of from about 12 to 65° C. The chilled mold relative to the injection molder temperature sets the injected food mass and prevents its expansion. The shaped mold can have virtually any shape including large pieces up to several feet across and several feet long. The screw feed and the high food pressures apply high mechanical and shear forces to the farinaceous composition and greatly disrupt the native starch structure during the cooking. A suitable example of such an injection molder assembly is a single screw extruder with a ram die available from Cincinnati Milacron, Inc. model VSX 85 T-4.4402. The molded composition is then removed from the mold for further processing. The starchy farinaceous compositions that can be injection molded have been described above and include the formulations in Table 1. Additionally, another set of examples of formulas that can be utilized in the injection molding system are presented below in Table 2.

TABLE 2

| Ingredient | #10 | #11 | #12 | #13 | #14 |
|---|---|---|---|---|---|
| Corn Flour | 42 | | | | |
| Wheat Flour | 31 | | | | |
| Oat Flour | 21 | | | | |
| Sugar | 4 | | | | |
| Salt | 2 | | | | |
| Pre-gelatinized corn pellets | | 100 | | | |
| Pre-gelatinized wheat pellets | | | 100 | | |
| Cooked, bumped, tempered rice | | | | 100 | |
| Corn grits | | | | | 100 |

The compositions can be injection molded following a process wherein the ingredients can be fed to a single screw extruder with a ram die available from Cincinnati Milacron, Inc. model VSX 85 T-4.4402. The preferably temperatures of the extruder and chamber are as described above. After injection of the food mass into the mold it is held in the relatively cooler mold, preferably at a temperature of from 12 to 65° C., for about 5 to 20 seconds to form the cooked starchy farinaceous composition that retains its unexpanded shape after removal from the mold.

### Flash Frying the Cooked Starchy Farinaceous Composition

As discussed above the product produced after the cooking step is an expandable food product. Thus, if the product is heated it will generally expand 2 to 10 fold. There are several common problems that are encountered in expanding the food products. There are always pieces that do not expand and stay as hard shapes like unpopped popcorn. These are unacceptable to consumers because they are inedible. Pieces that are lying on top of each other during the expansion step occasionally stick to each other and when this happens neither piece expands. Finally, it has been difficult to achieve adequate retention of coatings such as flavorings or seasonings on the expandable products or the expanded products. The present inventors have found that flash frying for a very short period of time reduces one or more of these prior art problems.

One suitable flash frying is any edible oil such as a vegetable oil, a shortening, or paraffin. Preferably these media are at a temperature of from 145 to 205° C., more preferably at a temperature of from 180 to 195° C. An alternative flash fry media comprises a heated caustic bath, preferably of 1% by weight baking soda and 99% by weight water, at a temperature of from about 70 to 85° C. The expandable food product is preferably flash fried for a period of time of from 1 to 15 seconds, more preferably from 1 to 10 seconds and most preferably from 1 to 5 seconds. The flash fried product is then removed from the frying media, excess frying media is removed, and the pieces are cooled. The flash frying causes only minimal expansion of the expandable food product of less than or equal to 10%. Exposing the expandable food product to the flash frying media for more than 15 seconds is undesirable and can actually reduce the subsequent expansion upon further heating. Longer frying times can also led to pre-mature expansion of the product which is not desirable. The flash frying causes the expandable food product to develop porosity and tackiness in the outer skin layer that is especially beneficial in enhancing the retention of coatings on the products. The coatings that can be applied at this time include the seasonings and flavor agents as described above including non-browning non-reducing sugars. The flash fried products exhibit enhanced expansion when subsequently heated to an expansion temperature. The enhanced expansion can include enhanced expanded size and an enhanced number of pieces that expand. The flash frying process only adds about 5 to 20% by weight oil to the expandable food product; however the process makes the expanded product taste as if it has much higher oil level which is desirable to consumers. For example, typical microwavable popcorn has a fat level of over 50% by weight. The process enables a low fat product to taste as if it has a higher, desirable fat level. In certain formulations the expanded flash fried product can taste as if it were prepared by deep frying. The coatings can be applied by any manner known in the art including dusting, dipping, rotary drum, or by spraying on with a liquid carrier such as water or oil. As discussed the flash frying increases porosity and tackiness of the material so any coating adheres particularly well.

### Expanding the Expandable Food Product

The cooled flash fried expandable food product can be expanded by a subsequent heating step. The heating can be accomplished by the manufacturer prior to distribution to consumers or it can be done by a consumer. The heat source for expansion can comprise virtually any heat source including an oven, hot air, microwave oven, puffing in a puffing tower, puffing in a puffing gun, frying or in a cereal puffing machine such as those used to make rice cakes. Puffing towers, puffing guns and their operation are known to those of ordinary skill in the art. Preferably if an oven is used it is set at a temperature of from 175 to 260° C., and more preferably from 200 to 245° C.

Rice cake forming machines are well known in the art and their operation will only be briefly described. They are also known as grain popping machines since grains other than rice can be use, although it is the most popular, and are available from many manufacturers including Real Foods Pty, Ltd. of St Peters NSW, Australia. Typically, the grain is equalized to a moisture level of from about 8 to 20% by weight, more preferably 11 to 18%. The grain is loaded into a feed bin of the rice cake forming machine. The feed bin meters the appropriate amount of grain into a mold. The mold typically has a stationary heated lower platen mold half and a heated upper platen having a reciprocally movable piston. After the grain has been deposited in the lower platen mold half the upper platen is lowered and its piston compresses the grains in the mold. The platens are typically heated to a temperature of from about 170 to 320° C., more preferably to 200 to 300° C. The piston initially applies a pressure of from about 3 to 15 MPa (30 to 150 bars), more preferably from 4 to 10 MPa (40 to 100 bars). The grains are typically compressed and heated for about 1 to 20 seconds and then the piston is rapidly retracted a distance of from about 3 to 25 millimeters to decrease the pressure and puff the grains. The puffed grains fill the expanded mold and bond to each other. The puffed cake is then removed from the mold. A typical final moisture of the cake is from about 2 to 10% by weight, more preferably from 3 to 6%. The cakes are cooled and then packaged. The cooled cakes are also sometimes dusted or sprayed with seasonings, although these have not adhered well in past attempts. If the coating is sprayed it may be necessary to dry the coated cakes down to the desired moisture prior to packaging.

The present inventors have found that flash fried expandable food pieces prepared according to the present invention can be used in place of the typical grains in a puffed cereal cake machine. When the expandable food pieces are used in place of the grains it results in a puffed cereal cake that has improved organoleptic properties and seasoning retention properties. In addition, the texture of the puffed cereal cake is very improved. The cooled flash fried expandable food piece(s) are loaded into the puffed cereal cake forming machine. At this point a starch or flour can be added to the material as is known in the art to improve the molding and puffing. Because the expandable food pieces can be made any size and shape it is possible to form them so only one piece is necessary to form a cake; however, it is more preferable to use a plurality of pieces. The loaded flash fried expandable food piece(s) are then heated and puffed in the machine. The cooked puffed cereal cake is then ejected. If desired, an optional step includes coating the puffed cereal cake with the described seasonings and flavor agents noted above. The coating can either be a dry coating, oil spray and then a dry coating or a sprayed coating. The coating can be applied in any conventional manner including using a spray system, a dusting system, a dip system, or a rotary coating drum. Coatings can also include vitamins and minerals known in the art. When the coating is applied using a liquid it may be necessary to dry the cereal cake down to the desired moisture content of 2 to 10%, noted above, prior to cooling. The puffed cereal cakes are packaged for distribution to consumers.

An alternative method as described in the present invention is to flash fry the cooked starchy farinaceous material as described and immediately upon exiting the fryer, dry seasons are applied to the flash fried composition and tumbled for blending. The cooled, seasoned flash fried expandable food piece(s) are then loaded into the puffed cereal cake forming machine. At this point a starch or flour can be added to the piece(s) as is known in the art to improve the molding and puffing. The loaded seasoned, flash fried expandable food piece(s) are then heated and puffed in the machine. The cooked puffed cereal cake is then ejected and optionally the puffed cereal cake can again be seasoned with coatings in the manner as described above.

Puffed cereal cakes prepared according to the present invention have numerous benefits. The texture of the puffed cereal cakes is improved compared to typical cereal cakes. They have improved crispness and mouth feel. When the flash fry media used on the grain is an edible oil the cereal cake has a desirable higher fat taste while remaining a low fat product. Consumers find this improved taste to be highly desirable. Because of the short exposure and high temperature of the media the actual fat level is not increased greatly. A fat content of 5 to 20% is typical. This compares with topical oil applications of 10 to 30% to help retain dry seasonings in the prior art process. In addition, the pleasing taste is distributed through out the entire cake. Another benefit of the present invention is that the puffed cereal cake has much higher coating retention properties. Coatings adhere within and around the grains and the taste is perceived through out the entire cake.

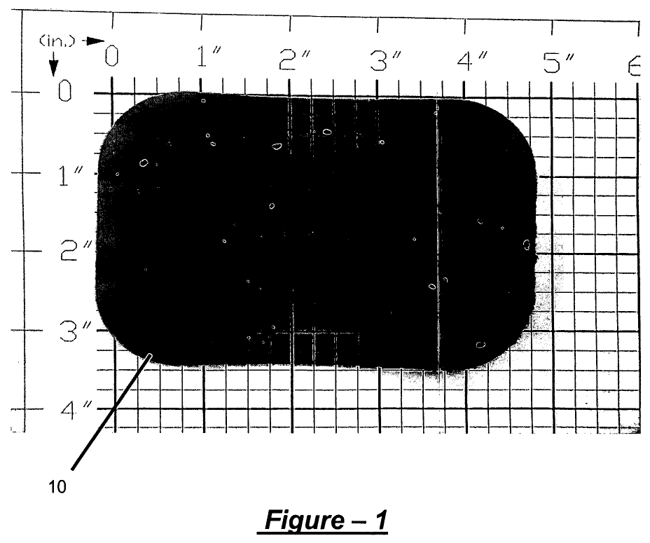

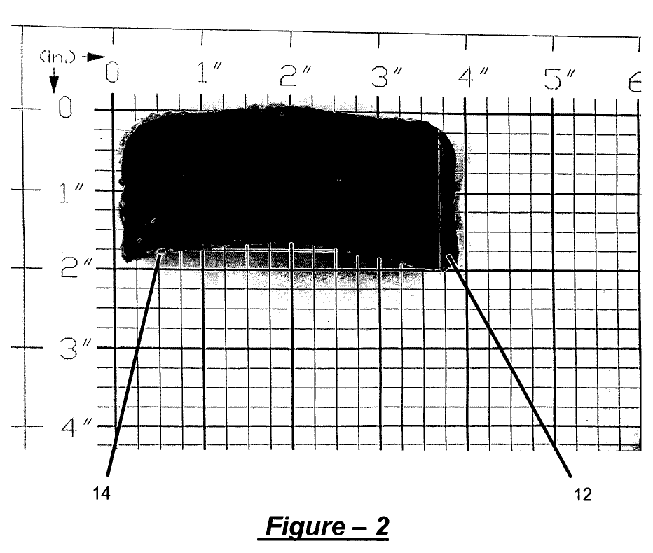

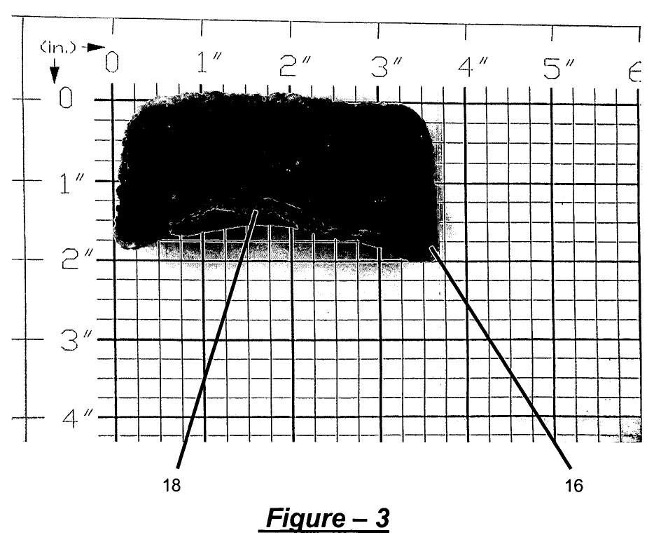

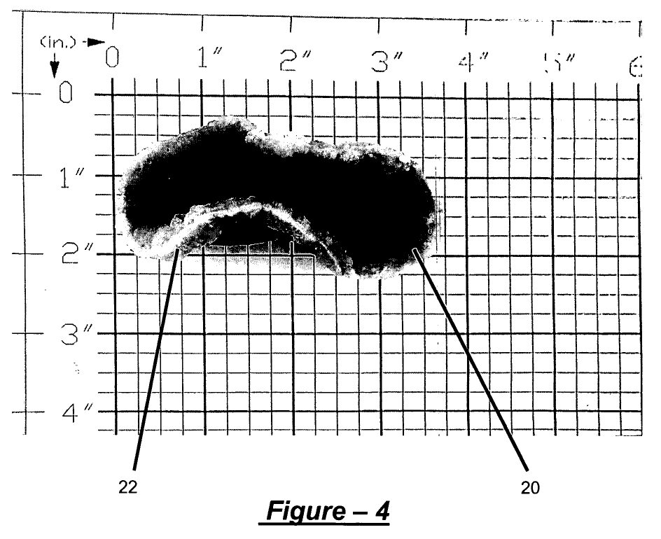

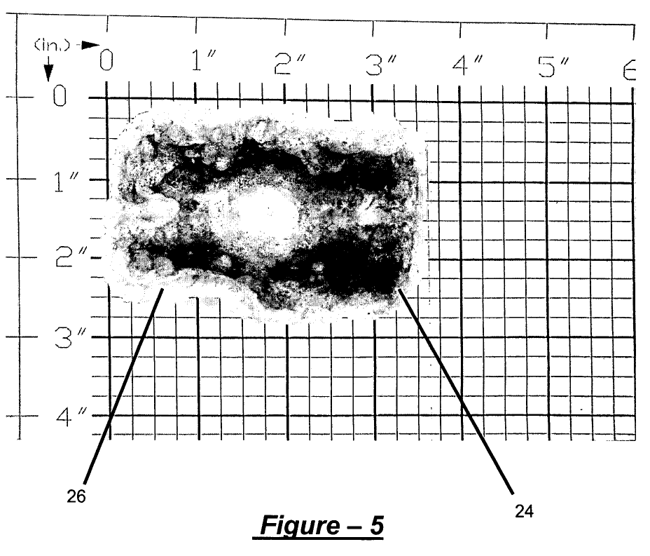

In FIG. 1 a photograph of a starchy farinaceous composition that has been injection molded into a piece according to the present invention is shown at 10. The composition was 100% corn grits that were injection molded by the process described above. Typically, size 10 corn grits can be used at a moisture of about 14% with the temperature preferably set at about 165° C. and a pressure of about 26,000 psi. A series of the pieces 10 were flash fried in corn oil at a temperature of 182° C. for different periods of time. In FIG. 2 an injection molded piece 10 is shown at 12 after 3 seconds of flash frying. The flash fried piece 12 is beginning to show a small amount of porosity 14 on its surface, particularly near the edges of the piece 12. In FIG. 3 an injection molded piece 10 is shown at 16 after 6 seconds of flash frying. The flash fried piece 16 is beginning to show more porosity 18 on its surface, particularly near the edges of the piece 16. In FIG. 4 an injection molded piece 10 is shown at 20 after 10 seconds of flash frying. The flash fried piece 20 has a more extensive amount of porosity 22 on its surface in addition to the edges of the piece 20. In FIG. 5 an injection molded piece 10 is shown at 24 after 15 seconds of flash frying. The flash fried piece 24 shows an extensive amount of porosity 26 over nearly the entire surface and the edges of the piece 24. Any pieces prepared according to the composition formulations disclosed in Tables 1, 2, and the general description above can be used to create expandable food products that will respond similarly to the flash frying. The flash fried pieces 12, 16, 20, and 24 all exhibit enhanced expansion compared to similar pieces that have not been flash fried. The enhancement is in terms of a greater expansion and/or a greater percentage that expand. The flash fried pieces 12, 16, 20, and 24 have an enhanced ability to retain coatings. The flash fried pieces also have a desirable organoleptic of tasting as if they have a higher fat content than they actually do. This is a desirable property for consumers.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. A method of forming an expandable food product comprising the steps of:
a) providing a starchy farinaceous composition;
b) cooking the starchy farinaceous composition; and
c) flash frying the cooked composition in a frying media at a temperature of from 145 to 205° C. for a period of time of from 1 to 15 seconds, thereby forming an expandable food product.

2. The method as recited in claim 1, wherein step a) comprises providing a starchy farinaceous composition having from 1 to 100% by weight of a starchy farinaceous material.

3. The method as recited in claim 2, comprising selecting the starchy farinaceous material from a barley, a buckwheat, a corn, a millet, an oat, a rice, a rye, a sorghum, a wheat, or a combination thereof.

4. The method as recited in claim 2, further comprising pretreating the starchy farinaceous material by rotary cooking, bumping, pre-gelatinizing, or a combination thereof prior to its incorporation in the starchy farinaceous composition.

5. The method as recited in claim 1, wherein step a) comprises providing a starchy farinaceous composition comprising at least one of a fruit, a sweetener, a flavorant, a colorant, a texturizing agent, a preservative, a lubricant, an emulsifier, an edible oil, a vitamin, a mineral, a protein source, or a seasoning.

6. The method as recited in claim 1, wherein step a) comprises providing a starchy farinaceous composition having at least one sweetener present in an amount of from 1 to 50% by weight based on the total weight of the composition.

7. The method as recited in claim 1, wherein step a) comprises providing a starchy farinaceous composition having at least one fruit present in an amount of from 1 to 50% by weight based on the total weight of the composition.

8. The method as recited in claim 1, wherein step a) comprises providing a starchy farinaceous composition having at least one edible oil present in an amount of from 1 to 20% by weight based on the total weight of the composition.

9. The method as recited in claim 1, wherein step b) comprises rotary cooking the starchy farinaceous composition.

10. The method as recited in claim 1, wherein step b) comprises cooking the starchy farinaceous composition in an extruder cooker at a temperature of from 90 to 205° C.

11. The method as recited in claim 1, wherein step b) comprises cooking the starchy farinaceous composition in an injection molder assembly at a pressure of from 10,000 to 50,000 pounds per square inch.

12. The method as recited in claim 1, wherein step b) further comprises drying the cooked starchy farinaceous composition to a moisture content of from 10 to 25% by weight prior to step c).

13. The method as recited in claim 1, wherein step b) comprises flash frying the cooked composition in a frying media comprising an edible oil.

14. The method as recited in claim 1, wherein step b) comprises flash frying the cooked composition in a frying media comprising a paraffin.

15. The method as recited in claim 1, wherein step c) comprises flash frying the cooked composition in a frying media for a period of time of from 1 to 10 seconds.

16. The method as recited in claim 1, further comprising after step c) the step of coating the expandable food product with at least one of a seasoning, a sweetener, or a flavorant.

17. The method as recited in claim 1, further comprising after step c) heating the expandable food product thereby expanding the expandable food product to form an expanded food product.

18. The method as recited in claim 17, wherein the heating step is carried out in one of an oven, hot air, a microwave oven, a puffing tower, a puffing gun, a frying media, a puffed cereal cake machine.

19. The method as recited in claim 18, further comprising expanding the expandable food product in an oven set at a temperature of from 175 to 260° C.

20. An expandable food product prepared according to the method of claim 1.

21. An expanded food product prepared according to the method of claim 17.

22. A method of forming an expandable food product comprising the steps of:
a) providing a starchy farinaceous composition;
b) cooking the starchy farinaceous composition; and
c) flash frying the cooked composition in a caustic media at a temperature of from 70 to 85° C. for a period of time of from 1 to 15 seconds, thereby forming an expandable food product.

23. The method as recited in claim 22, wherein step a) comprises providing a starchy farinaceous composition having from 1 to 100% by weight of a starchy farinaceous material.

24. The method as recited in claim 23, comprising selecting the starchy farinaceous material from a barley, a buckwheat, a corn, a millet, an oat, a rice, a rye, a sorghum, a wheat, or a combination thereof.

25. The method as recited in claim 23, further comprising pretreating the starchy farinaceous material by rotary cooking, bumping, pre-gelatinizing, or a combination thereof prior to its incorporation in the starchy farinaceous composition.

26. The method as recited in claim 22, wherein step a) comprises providing a starchy farinaceous composition comprising at least one of a fruit, a sweetener, a flavorant, a colorant, a texturizing agent, a preservative, a lubricant, an emulsifier, an edible oil, a vitamin, a mineral, a protein source, or a seasoning.

27. The method as recited in claim 22, wherein step a) comprises providing a starchy farinaceous composition having at least one sweetener present in an amount of from 1 to 50% by weight based on the total weight of the composition.

28. The method as recited in claim 22, wherein step a) comprises providing a starchy farinaceous composition having at least one fruit present in an amount of from 1 to 50% by weight based on the total weight of the composition.

29. The method as recited in claim 22, wherein step a) comprises providing a starchy farinaceous composition having at least one edible oil present in an amount of from 1 to 20% by weight based on the total weight of the composition.

30. The method as recited in claim 22, wherein step b) comprises rotary cooking the starchy farinaceous composition.

31. The method as recited in claim 22, wherein step b) comprises cooking the starchy farinaceous composition in an extruder cooker at a temperature of from 90 to 205° C.

32. The method as recited in claim 22, wherein step b) comprises cooking the starchy farinaceous composition in an injection molder assembly at a pressure of from 10,000 to 50,000 pounds per square inch.

33. The method as recited in claim 22, wherein step b) further comprises drying the cooked starchy farinaceous composition to a moisture content of from 10 to 25% by weight prior to step c).

34. The method as recited in claim 22, wherein step c) comprises flash frying the cooked composition in a frying media for a period of time of from 1 to 10 seconds.

35. The method as recited in claim 22, further comprising after step c) the step of coating the expandable food product with at least one of a seasoning, a sweetener, or a flavorant.

36. The method as recited in claim 22, further comprising after step c) heating the expandable food product thereby expanding the expandable food product to from an expanded food product.

37. The method as recited in claim 36, wherein the heating step is carried out in one of an oven, hot air, a microwave oven, a puffing tower, a puffing gun, a frying media, a puffed cereal cake machine.

38. The method as recited in claim 37, further comprising expanding the expandable food product in an oven set at a temperature of from 175 to 260° C.

39. An expandable food product prepared according to the method of claim 22.

40. An expanded food product prepared according to the method of claim 36.
